(19) United States
(12) Patent Application Publication
(10) Pub. No.: US 2025/0015289 A1
(43) Pub. Date: Jan. 9, 2025

(54) MULTIMODAL SILICON-CARBON COMPOSITE MATERIAL, AN ANODE COMPRISING THE SAME AND A METHOD TO MANUFACTURE OF THE SAID COMPOSITE MATERIAL

(71) Applicants: GROUP14 TECHNOLOGIES, INC., Woodinville, WA (US); CELLFORCE GROUP GMBH, Tubingen (DE)

(72) Inventors: Henry R. COSTANTINO, Woodinville, WA (US); Heino SOMMER, Tubingen (DE)

(21) Appl. No.: 18/711,531

(22) PCT Filed: Nov. 18, 2022
(86) PCT No.: PCT/US2022/080178

§ 371 Date: May 17, 2024

Related U.S. Application Data
(60) Provisional application No. 63/281,522, filed on Nov. 19, 2021.

(51) Int. Cl. H01M 4/587; H01M 4/02; H01M 4/04; H01M 4/133; H01M 4/1393; H01M 4/62; H01M 10/0525

(52) U.S. Cl. CPC H01M 4/587; H01M 4/0404; H01M 4/133; H01M 4/1393; H01M 4/622; H01M 10/0525; H01M 2004/021; H01M 2004/027

(57) ABSTRACT

Disclosed herein are silicon-carbon composite mixtures containing a first silicon-carbon composite material including a porous carbon scaffold containing micropores and mesopores and a total pore volume no less than 0.5 cm³/g, a silicon content from 30% to 70% and a plurality of particles having a Dv50 of 6 μm to 20 μm; as well as at least a second silicon-carbon composite material including at least a second carbon scaffold containing micropores and mesopores and a total pore volume no less than 0.5 cm³/g, a silicon content from 30% to 70%, and a plurality of particles having a Dv50 of 1 μm to 6 μm; and 10% to 90% by mass of the first silicon-carbon composite material and 10% to 90% of the at least one further silicon-carbon composite material. Also disclosed herein are methods of manufacturing silicon-carbon composite mixtures, methods of manufacturing anode electrodes containing a silicon-carbon composite mixture, and methods of manufacturing electrochemical energy storage devices containing a silicon-carbon composite mixture.

### BACKGROUND

### Technical Field

The present disclosure relates to a particulate silicon-carbon composite mixture (silicon-carbon composite) comprising a multimodal particle size distribution. The present disclosure further relates to a method of manufacturing the same silicon-carbon composite mixture, a method of manufacturing an electrode comprising the same silicon-carbon composite mixture, and employing the same as an anode for lithium-based energy storage devices, and electrochemical energy storage devices comprising the same.

### Description of the Related Art

The silicon-carbon composite mixture can be produced from carbon materials comprising a pore volume comprising micropores, mesopores, and/or macropores. Such carbon mixtures can serve as a scaffold for creation of silicon-carbon composite materials. The impregnation of the pore volume of porous carbon materials with silicon is a known method. The impregnated silicon can be provided in nano size. In general, silicon comprises a significantly higher energy density than, e.g., graphite. For example, the energy density of silicon exceeds the energy density of graphite by a factor of ten.

Further to impregnation, such impregnated carbon materials may be coated such that a still existing porous surface is further reduced. Possible coatings may consist, e.g., a polymer, in particular a conductive polymer, a carbon or a metal oxide. The benefit of carbon materials which are impregnated and/or coated is the improvement of the stability of the lithium-ion storage capacity, which increases the charging capacity of lithium-ion battery cells.

Moreover, carbon materials impregnated with silicon may be used in a combination with other materials as a material composition. Known material compositions include binders and/or carbon particles. Such material compositions are typically utilized in electrochemical cells, in particular in lithium-ion battery cells as electrode material, in particular anode material.

In addition to silicon, such material compositions can also include other materials such as tin or other electrochemical modifications with lithium alloys. Lithium alloys may store large amounts of lithium per unit weight depending on the alloy. However, due to the occurrence of a strong volume expansion during a complete reaction with lithium, the practical use of such alloys is limited. When the lithium is removed a volume expansion occurs, and a volume contraction occurs when the lithium is removed from the silicon. This effect may shorten the lifetime and results in low performance of a corresponding electrode.

To overcome this disadvantage of such lithium alloys, attempts are being made to increase the content of electrochemical alloy modifications in an anode composition without affecting cycle stability.

This can be achieved by means of micro- or nanostructured electrochemical alloy modifications, by compounding of carbon with electrochemical alloy modifications, or by the deposition of electrochemical alloy modifications on carbon using vacuum conditions or high temperature treatments. However, none of these processes is yet able to exclude an influence on the cycle stability. In particular, with increasing number of cycles, the electrochemical cells are still prone to capacity loss, in which a solid electrolyte intermediate phase (SEI layer) forms on the negative electrode based on a variety of different mechanisms, competing with reversible lithium intercalation.

A SEI layer usually forms due to a reduction of organic solvents and anions on an electrode surface during charge and discharge cycles of an electrochemical cell. In such case, a large part of the formation already occurs during the first charge and discharge cycle of the electrochemical cell. In the prior art, it is known that the SEI layer plays an important role in terms of safety, performance and cycle life of electrochemical cells, such as Li-ion battery cells.

Due to the SEI layer, irreversible consumption of Li-ions from the cathode occurs at the anode, resulting in a capacity loss that usually occurs in a first lithiation/delithiation cycle. Due to continuous increase of the SEI layer, the resistance for the diffusion of the Li-ions through the SEI layer also increases.

Since silicon tends to expand and contract continuously, leading to cracking and reformation, different sizes and different shapes of silicon are used to prevent this. Thus, different sizes and shapes of silicon are already known in the prior art. In particular, it is known in the prior art that nano scale based features for silicon are advantageous for use in electrochemical cells, especially in Li-ion batteries.

For example, US Publication No. 2017/0170477 discloses a composite comprising a porous carbon scaffold and silicon, wherein the composite comprises 15 to 85 wt % silicon and a nitrogen inaccessible volume in the range of 0.05 cm³/g to 0.5 cm³/g, and wherein the composite comprises a plurality of particles having a particle scaffold density in the range of 1.5 g/cm³ to 2.2 g/cm³ as measured by helium pycnometry.

Due to the rapidly increasing importance of electrochemical cells, in particular Li-ion batteries, there is a continuous need for further development and improvement in the field of silicon-carbon composites, both in materials and in processes for the production of such materials.

### BRIEF SUMMARY

It is therefore an objective of the present disclosure to provide a composite mixture for an electrode as well as for an electrochemical storage device, such as a lithium-ion battery, which comprises improved electrochemical properties.

This objective is solved by providing a silicon-carbon composite mixture comprising a multimodal particle size distribution. The particle size distribution can be measured as known in the art. For example, the particle size distribution can be measured by laser light scattering of the particles in suspension, or a powder time-of-flight methodology, or other methods known in the art. The particle size distribution can be expressed as the number particle distribution or volume particle distribution, as known in the art. Accordingly, the particle size distribution can be expressed as Dvx, where D represents particle diameter, v represents the value corresponding to volume basis, and x represents the cumulative percentage of particles. For example, Dv1, Dv10, Dv50, Dv90, and Dv99 are the diameter at which 1%, 10%, 50%, 90%, and 99% of the plurality of particles in the given volume distribution reside below the named micron size. The particle size distribution is bounded by the DO (smallest particle in the distribution) and Dv100 (maximum size of the largest particle); the Dv50 is the volume average particle size. The particle size distribution can be described in terms of one or more modes present in the particle size distribution, where the concept of mode is known in the art, for example is a maxima in the distribution. Particle size distributions can be monomodal or multimodal such as bimodal or trimodal. Modes within multimodal particle size distributions can comprise distinct local maxima within the particle distribution and/or shoulders that can be resolved from the first and/or second derivative(s) of the particle size distribution.

Due to the rapidly increasing importance of electrochemical cells, in particular Li-ion batteries, there is a continuous need for further development and improvement in the field of silicon-carbon composites, both in materials and in processes for the production of such materials.

It is therefore an object of the present disclosure to provide a composite mixture for an electrode as well as for an electrochemical storage device, such as a lithium-ion battery, which comprises improved electrochemical properties.

Each of the embodiments herein comprise mixtures comprising two or more silicon-carbon composite materials, wherein each material has a different Dv50 or range of Dv50.

Accordingly, one embodiment provides a silicon-carbon composite mixture comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second or at least one further silicon-carbon composite material comprising:
   i. a second or at least one further carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm; and
c) 10% to 90% by mass of the first silicon-carbon composite material and 10% to 90% by mass of the second or at least one further silicon-carbon composite material.

In a further embodiment the blended material may include an optional third or more silicon-carbon composite material, wherein each of the third or more silicon-carbon composite materials has a Dv50 of 1 μm to 6 μm. The silicon-carbon composite thus may comprises at least one further silicon-carbon composite, where the at least one further silicon-carbon composite comprises at least one further silicon carbon scaffold comprising micropores and mesopores and a total pore volume no less than 0.5 cm³/g, a silicon content from 30% to 70% and a plurality of particles comprising a Dv50 of 1 μm to 6 μm.

In one embodiment the silicon-carbon composite mixture can comprise 10% to 90% by mass of the first silicon-carbon composite material and 10% to 90% by mass of the second or at least one further silicon-carbon composite material.

One additional embodiment provides a silicon-carbon composite mixture comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm;
c) 10% to 90% by mass of the first silicon-carbon composite material and 10% to 90% by mass of the second silicon-carbon composite material;
d) an average surface area of less than 30 m²/g;
e) E greater than 0.01, wherein E is defined as 1−(tap density for composite mixture)/(mass averaged tap density for individual fractions); and
f) for the determination of E measurement of tap density of the silicon-carbon composite mixture and the individual fractions comprising each mode are measured under otherwise identical conditions.

Another embodiment provides a silicon-carbon composite mixture comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm;
c) 10% to 90% by mass of the first silicon-carbon composite material and 10% to 90% by mass of the second silicon-carbon composite material;
d) an optional third or more silicon-carbon composite material each having a different Dv50; and
e) an average surface area of less than 30 m²/g; and
f) E greater than 0.01, wherein E is defined as 1−(conductivity for composite material)/(mass averaged conductivity for individual fractions).

As used herein, a “different Dv50” means that the third or more silicon-carbon composite or the at least one further silicon-carbon composite comprises a plurality of particles comprising a Dv50 of 1 μm to 6 μm.

The silicon-carbon composite mixture can in one embodiment comprise 10% to 90% by mass of the first silicon-carbon composite material and 10% to 90% by mass of the second or at least one further silicon-carbon composite material.

Still another embodiment provides a method to manufacture a silicon-carbon composite mixture comprising the steps:
a) providing a porous carbon scaffold;
b) comminution the porous carbon scaffold to produce at least two particulate fractions, comprising:
   i. a first porous carbon composite material comprising a plurality of particles with Dv50=6 μm to 20 μm;
   ii. a second porous carbon composite material comprising a particle size distribution with Dv50=1 μm to 6 μm;
c) impregnation of silicon into the pores of the first and second porous carbon composite materials by chemical vapor infiltration; and
d) blending of the first particulate silicon-carbon composite material and the second particulate silicon-carbon composite material.

Yet another embodiment provides a method to manufacture a silicon-carbon composite mixture comprising the steps:
a) providing a porous carbon scaffold;
b) comminution the porous carbon scaffold to produce at least two particulate fractions, comprising:
   i. a first porous carbon composite material comprising a plurality of particles with Dv50=6 μm to 20 μm;
   ii. a second porous carbon composite material comprising a particle size distribution with Dv50=1 μm to 6 μm;
c) impregnation of silicon into the pores of the at least two particulate fractions of porous carbon composite materials by chemical vapor infiltration;
d) applying a coating onto the surface of the first and second porous carbon composite material by chemical vapor deposition; and
e) blending of the first particulate silicon-carbon composite material and the second particulate silicon-carbon composite material to produce a blended material.

In still further embodiments the blended material may include an optional third or more silicon-carbon composite material, wherein each of the third or more silicon-carbon composite materials has a unique Dv50.

As used herein, a “unique Dv50” means that the third or more silicon-carbon composite or the at least one further silicon-carbon composite comprises a plurality of particles comprising a Dv50 of 1 μm to 6 μm.

One embodiment provides an anode electrode, comprising a silicon-carbon composite mixture comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm; and
c) 10% to 90% by mass of the first silicon-carbon composite material and 10% to 90% by mass of the second silicon-carbon composite material.

The term carbon refers to a material or substance consisting of carbon or at least comprising carbon. In this regard, a carbon material may comprise high purity, amorphous and crystalline materials. A carbon may be an activated carbon, a pyrolyzed dried polymer gel, a pyrolyzed polymer cryogel, a pyrolyzed polymer xerogel, a pyrolyzed polymer aerogel, an activated dried polymer gel, an activated polymer cryogel, an activated polymer xerogel, an activated polymer aerogel, or a combination thereof. In one embodiment, the carbon material has a high micropore volume ratio. In a further embodiment, a carbon is producible by a pyrolysis of coconut shells or other organic waste. In this regard, a polymer is a molecule comprising two or more repeating structural units. A porous carbon offers the advantage that it is usually easy to produce, usually has low impurities and a large pore volume. As a result, a porous carbon exhibits good electrical conductivity and high mechanical and chemical stability.

Typically, the porous carbon has a pore space, also referred to as a pore volume, wherein the pore space is a group of voids (pores) in the carbon that is fillable with a gas or fluid.

The silicon portion may be a pure silicon or a material composition comprising silicon. For example, the silicon portion may be at least one alloy. An alloy may be a silicon-titanium alloy (Si—Ti), a silicon iron alloy (Si—Fe), a silicon nickel alloy (Si—Ni). In a further embodiment, the silicon portion may consist of P-dopants, As-dopants or N-dopants. A P-dopant is usually a phosphorus dopant, an As-dopant is usually an arsenic dopant and an N-dopant is usually a nitrogen dopant.

The silicon content of the total mass of the multimodal silicon-carbon composite material is usually between 30% and 70%, especially between 40% and 60%.

In one further embodiment, the surface area of the silicon-carbon composite mixture is less than 30 m²/g. The surface area is measured according to the BET measurement which is a term for an analytical method for determining the size of surfaces, in particular porous solids, by means of gas adsorption. In a further embodiment, the BET surface area is between 5 m³/g and 25 m³/g.

In one further embodiment, the anode electrode has a density comprising E greater than 0.01, wherein E is defined as 1−(density for composite mixture)/(mass averaged density for individual fractions), wherein density is the electrode density as measured in an electrode composed of 70 wt % composite, 20 wt % graphite, and 2 wt % Super C65, and 8% PAA.

In one further embodiment, for the determination of E measurement of electrode properties of the silicon-carbon composite mixture and the individual fractions comprising each mode are measured under otherwise identical conditions.

In one further embodiment the anode electrode has a density comprising E greater than 0.01, wherein E is defined as 1−(tap density for composite mixture)/(mass averaged tap density for individual fractions), wherein density is the electrode density as measured in an electrode composed of 70 wt % composite, 20 wt % graphite, and 2 wt % Super C65, and 8% PAA.

In one further embodiment for the determination of E measurement of electrode properties of the silicon-carbon composite mixture and the individual fractions comprising each mode are measured under otherwise identical conditions.

In one further embodiment E is greater than 0.05. In one further embodiment E is greater than 0.1.

In one further embodiment, the silicon-carbon composite mixture comprises at least one further carbon and/or at least one binder. A binder is a binding agent or binding material. A binder thus refers to a material that can hold together individual components, in particular particles, of a substance, for example a carbon. A binder is typically arranged such that when particles are brought together with a corresponding binder, a cohesive mass is formed which can be further shaped into a new form.

In one further embodiment the at least one further carbon and/or the at least one binder is dissolved in an aqueous medium.

In one further embodiment, the silicon-carbon composite mixture is composed such that the silicon-carbon composite mixture has an electron density ranging from 1.05 g/cm³ to 1.5 g/cm³, or from 1.1 g/cm³ and 1.3 g/cm³. This offers the advantage that the particles comprise better contact with each other and thus the conductivity of the resulting electrode is improved.

In one further embodiment, the silicon-carbon composite mixture has an electrical conductivity ranging from 0.3 S/cm to 2 S/cm, or from 0.5 S/cm and 1.2 S/cm. This offers the advantage that the resistance of the electrode is reduced, thus allowing a faster reaction of the Li-ions with the silicon-carbon composite mixture. Hence, a charging speed of the lithium-ion cell may be increased.

In one further embodiment, the carbon is a hard carbon material, a graphitic carbon, or a metal oxide. For example, the metal oxide is a silicon oxide (SiO₂). Alternatively, a metal oxide is a titanium oxide (TiO₂), a tin oxide (SnO₂), or other metal oxide. A hard carbon material is a non-graphitizable carbon material. A hard carbon offers the advantage that it remains amorphous at elevated temperatures (typically >1500° C., whereas a “soft” carbon crystallizes and becomes graphite.

In one embodiment, the carbon may be a modified hard carbon. A modified hard carbon is a composite material comprising both a carbon, in particular a hard carbon, and a lithium alloy material. A lithium alloy material may be silicon, tin, germanium, nickel, aluminum, manganese, alumina (AI₂O₃), titanium, titanium oxide, sulfur, molybdenum, arsenic, gallium, phosphorus, selenium, antimony, bismuth, tellurium or indium or any other metal or metalloid capable of absorbing lithium.

In one further embodiment the binder is configured to bind the porous carbon and the silicon content of the first silicon-carbon composite, the porous carbon and the silicon-carbon portion of the further silicon-carbon composite and/or the first silicon-carbon composite and the further silicon-carbon composite. In a further embodiment, the binder is adapted to bind further materials to at least one of the respective silicon-carbon composites. Thus, a binder is generally arranged to hold together the components of the silicon-carbon composite mixture and optionally further carbon materials of the electrode which may be formed as an anode.

In one further embodiment, the silicon-carbon composite mixture comprises at least one further binder. This results in the advantage that carbon increases the conductivity of the electrode and thus provides improved conductivity. The at least one further binder further supports the mechanical stability. A further carbon may be a hard carbon material or a graphitic carbon or a metal oxide.

In one further embodiment, the silicon-carbon composite mixture comprises at least two binders, wherein a first binder is arranged to bind the porous carbon and the silicon-carbon portion of the first silicon-carbon composite and the porous carbon and the silicon portion of the at least one further silicon-carbon composite, and wherein the at least one further binder is arranged to bond the first silicon-carbon composite to the at least one further silicon-carbon composite.

Optionally, the silicon-carbon composite material comprises at least one further binder adapted to bond the first material component and the at least one further material component together.

In one further embodiment, the binder is a styrene-butadiene gum/carboxymethyl cellulose (CMC/SBR) mixture, a polyacrylic acid (PAA) and/or a lithium polyacrylic (LiPAA) or a sodium polyacrylic (NaPAA). In an alternative embodiment, the binder is formed as a fluoropolymer such as a polytetrafluoroethylene (PTFE), a perfluoroalkoxy polymer resin (PFA), a fluorinated ethylene propylene (FEP), a polyethylene tetrafluoroethylene (ETFE), a polyvinyl fluoride (PVF), a polyethylene chlorotrifluoroethylene (ECTFE), a (polyvinylidene fluoride (PCDF), a (polychlorotrifluoroethylene (PCTFE), a trifluoroethanol, or combinations of at least one of these materials with at least one other material. In a further embodiment, a binder is a polyimide or a copolymer of polyacrylic acid and styrene-butadiene. The present disclosure offers the advantage that the bimodal distribution of the composite enables a higher packing density and improved electrical conductivity of an anode electrode.

Yet another embodiment provides a method of manufacturing an anode electrode comprising a silicon-carbon composite mixture according to any one of the embodiments described herein, comprising the steps:
a) mixing the silicon-carbon composite mixture with at least one carbon, to create a mixture,
b) combining the mixture and a binder solution in a twin screw extruder, thereby forming an electrode paste,
c) applying the electrode paste to a conductor thereby producing at least one electrode,
d) drying the at least one electrode at a temperature of 100° C. to 140° C.

One objective of the present disclosure is to provide an electrical energy storage device (e.g., a lithium ion battery) comprising at least one anode electrode according to any one of the embodiments described herein.

Therefore, another embodiment provides an electrochemical storage device, especially formed as a lithium-ion-battery, comprising:
a) at least one anode electrode, according to any one of the embodiments described herein;
b) at least one electrode, formed as a cathode, comprising a transition metal oxide;
c) a separator disposed between the cathode and the anode; and
d) an electrolyte comprising lithium ions.

Still another embodiment provides for usage of a silicon-carbon composite mixture in an anode electrode, the silicon-carbon composite material comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm;
c) 10% to 90% by mass of the first silicon-carbon composite material and 10% to 90% by mass of the second silicon-carbon composite material.

In one further embodiment of such use the surface area of the silicon-carbon composite mixture is less than 30 m²/g.

In yet another embodiment provides for usage of a silicon-carbon composite mixture in an anode electrode, the silicon-carbon composite material comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm;
c) 10% to 90% by mass of the first silicon-carbon composite material and 10% to 90% by mass of the second silicon-carbon composite material; and
d) wherein the anode is comprised a first and second layer, the first layer comprises the first silicon-carbon composite material and the second layer comprising the second silicon-carbon composite material.

In one further embodiment of such use the anode electrode has a density comprising E greater than 0.01, wherein E is defined as 1−(density for composite mixture)/(mass averaged density for individual fractions), wherein density is the electrode density as measured in an electrode composed of 70 wt % composite, 20 wt % graphite, and 2 wt % Super C65, and 8% PAA.

In one further embodiment of such use for the determination of E for the silicon-carbon composite mixture and the individual fractions comprising each mode are measured under otherwise identical conditions.

In one further embodiment of such use E is greater than 0.05. In one further embodiment of such use E is greater than 0.1.

Still another embodiment provides for usage of an anode electrode comprising a silicon carbon mixture to any one of the embodiments described herein in an electrochemical storage device. In one embodiment, an electrochemical storage device is a lithium-ion-battery.

### BRIEF DESCRIPTION OF THE DRAWINGS

In the figures, identical reference numbers identify similar elements. The sizes and relative positions of elements in the figures are not necessarily drawn to scale and some of these elements are enlarged and positioned to improve figure legibility. Further, the particular shapes of the elements as drawn are not intended to convey any information regarding the actual shape of the particular elements, and have been solely selected for ease of recognition in the figures.

FIG. 1 shows a differential volume plot for Silicon-Carbon Composite 22 (dashed line) and Silicon-Carbon Composite 23 (solid line).

FIG. 2 shows a differential volume plot for various blends of Silicon-Carbon Composite 22 and Silicon-Carbon Composite 23: 10/90 (dashed line), 50/50 (solid line), and 90/10 (dotted line).

### DETAILED DESCRIPTION

In the following description, certain specific details are set forth in order to provide a thorough understanding of various embodiments of the disclosure. However, one skilled in the art will understand that the disclosure may be practiced without these details.

Unless the context requires otherwise, throughout the present specification and claims, the word “comprise” and variations thereof, such as, “comprises” and “comprising” are to be construed in an open, inclusive sense, that is, as “including, but not limited to”.

In the present description, any concentration range, percentage range, ratio range, or integer range is to be understood to include the value of any integer within the recited range and, when appropriate, fractions thereof (such as one tenth and one hundredth of an integer), unless otherwise indicated. As used herein, the terms “about” and “approximately” mean±20%, ±10%, ±5% or ±1% of the indicated range, value, or structure, unless otherwise indicated. It should be understood that the terms “a” and “an” as used herein refer to “one or more” of the enumerated components. The use of the alternative (e.g., “or”) should be understood to mean either one, both, or any combination thereof of the alternatives.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Unless defined otherwise, all technical and scientific terms used herein have the same meaning as is commonly understood by one of skill in the art to which this disclosure belongs. As used in the specification and claims, the singular form “a”, “an” and “the” include plural references unless the context clearly dictates otherwise.

The above-described objects are solved by a multimodal silicon-carbon composite material (the terms “multimodal silicon-carbon composite material” and “silicon-carbon composite mixture” may be used interchangeably in some embodiments) having the features of embodiments disclosed herein. For example, one embodiment provides a silicon-carbon composite mixture comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm; and
c) 10% to 90% by mass of the first silicon-carbon composite material and 10% to 90% by mass of the second silicon-carbon composite material.

In some embodiments, the silicon-carbon composite mixture has a surface area of less than 30 m²/g.

In certain embodiments, E greater than 0.01, wherein E is defined as 1−(density for composite mixture)/(mass averaged density for individual fractions), wherein density is the electrode density as measured in an electrode composed of 70 wt % composite, 20 wt % graphite, and 2 wt % Super C65, and 8% PAA.

In certain embodiments, E greater than 0.01, wherein E is defined as 1−(density for composite mixture)/(mass averaged density for individual fractions). In some embodiments, density is the density as measured in an electrode composed of 70 wt % composite, 20 wt % graphite, and 2 wt % Super C65, and 8% PAA. In some specific embodiments, for the determination of E measurement of properties of the silicon-carbon composite mixture and the individual fractions comprising each mode are measured under otherwise identical conditions. In some embodiments, E is greater than 0.05. In certain embodiments, E is greater than 0.1.

One embodiment provides a silicon-carbon composite mixture comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second er silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm;
c) 10% to 90% by mass of the first silicon-carbon composite material and 10% to 90% by mass of the second silicon-carbon composite material;
d) a silicon-carbon composite mixture surface area of less than 30 m²/g;
e) E greater than 0.01, wherein E is defined as 1−(tap density for composite mixture)/(mass averaged tap density for individual fractions); and
f) for the determination of E measurement of tap density of the silicon-carbon composite mixture and the individual fractions comprising each mode are measured under otherwise identical conditions.

The tap density of particulate silicon-carbon composite material(s) and silicon-carbon composite mixture can be measured as known in the art. For example, tap density can be measured with a PT-TD300 Tap Density Tester, wherein a known mass of powder is loaded into a graduated cylinder, for example until filling the graduated cylinder to ½ to ¾ of its total capacity, the cylinder is loaded into the testing device, and the loaded cylinder tapped for a fixed number of taps (e.g., 250 taps) and the new tapped volume recorded, and this tapping process repeated until the point where the measured volume is no longer changing, for example within 2% of the previous reading.

In certain embodiments, the tap density of the particulate silicon-carbon material ranges from 0.3 g/cc to 0.5 g/cc, or from 0.4 g/cc to 0.6 g/cc, or 0.5 g/cc to 0.7 g/cc, or from 0.6 g/cc to 0.8 g/cc, or from 0.7 g/cc to 0.9 g/cc, or from 0.8 g/cc to 1.0 g/cc. In certain embodiments, the tap density of the particulate silicon-carbon material is greater than 1.0 g/cc.

In certain embodiments, the tap density of the particulate silicon-carbon mixture ranges from 0.3 g/cc to 0.5 g/cc, or from 0.4 g/cc to 0.6 g/cc, or 0.5 g/cc to 0.7 g/cc, or from 0.6 g/cc to 0.8 g/cc, or from 0.7 g/cc to 0.9 g/cc, or from 0.8 g/cc to 1.0 g/cc. In certain embodiments, the tap density of the particulate silicon-carbon mixture is greater than 1.0 g/cc.

Another embodiment provides a silicon-carbon composite mixture comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm;
c) 10% to 90% by mass of the first silicon-carbon composite material and 10% to 90% by mass of the second silicon-carbon composite material;
d) a surface area of less than 30 m²/g; and
e) E greater than 0.01, wherein E is defined as 1−(conductivity for composite mixture)/(mass averaged conductivity for individual fractions).

In some specific embodiments, for the determination of E measurement of properties of the silicon-carbon composite mixture and the individual fractions comprising each mode are measured under otherwise identical conditions. In some embodiments, conductivity is the conductivity as measured in an electrode composed of 70 wt % composite, 20 wt % graphite, and 2 wt % Super C65, and 8% PAA. In some embodiments, E is greater than 0.05. In certain embodiments, E is greater than 0.1.

One embodiment provides a method to manufacture a silicon-carbon composite mixture comprising the steps:
a) providing a porous carbon scaffold;
b) comminution the porous carbon scaffold to produce at least two particulate fractions, comprising:
   i. a first porous carbon composite material comprising a plurality of particles with Dv50=6 μm to 20 μm;
   ii. a second porous carbon composite material comprising a particle size distribution with Dv50=1 μm to 6 μm;
c) impregnation of silicon into the pores of the at least two particulate fractions of porous carbon composite materials by chemical vapor infiltration; and
d) blending of the first particulate silicon-carbon composite material and the at least one additional particulate silicon-carbon composite material.

In some embodiments, the mixture comprises the first fraction of the first silicon-carbon composite with a proportion of 60% to 90% by weight and the further fraction of the at least one further silicon-carbon composite with a proportion of 10% to 40%. In some more specific embodiments, the mixture comprises the first fraction of the first silicon-carbon composite with a proportion of 70% to 90% and the second silicon-carbon composite with a proportion of 10% to 30% by weight.

Another embodiment provides, a method to manufacture a silicon-carbon composite mixture comprising the steps:
a) providing a porous carbon scaffold;
b) comminution the porous carbon scaffold to produce at least two particulate fractions, comprising:
   a) a first porous carbon composite material comprising a plurality of particles with Dv50=6 μm to 20 μm;
   b) a second carbon composite material comprising a particle size distribution with Dv50=1 μm to 6 μm;
c) impregnation of silicon into the pores of the at least two particulate fractions of porous carbon composite materials by chemical vapor infiltration; and
d) applying a coating onto the surface of the at least two particulate fractions of the porous silicon-carbon composite by chemical vapor deposition; and
e) blending of the first particulate silicon-carbon composite material and the second silicon-carbon composite material.

One specific embodiment provides, an anode electrode, comprising a silicon-carbon composite mixture comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm; and
c) 10% to 90% by mass of the first silicon-carbon composite material and 10% to 90% by mass of the second silicon-carbon composite material.

In some embodiments, the silicon-carbon composite mixture has a surface area of less than 30 m²/g. In some embodiments, the silicon-carbon composite mixture has E greater than 0.01, wherein E is defined as 1−(density for composite mixture)/(mass averaged density for individual fractions). In some embodiments, E is defined as 1−(tap density for composite mixture)/(mass averaged tap density for individual fractions). In some embodiments, density is the electrode density as measured in an electrode composed of 70 wt % composite, 20 wt % graphite, and 2 wt % Super C65, and 8% PAA.

In some embodiments, E is greater than 0.05. In certain embodiments, E is greater than 0.1. In some embodiments, for the determination of E measurement of electrode properties of the silicon-carbon composite mixture and the individual fractions comprising each mode are measured under otherwise identical conditions.

In more specific embodiments, the silicon-carbon composite mixture comprises at least one further carbon and/or at least one binder. In certain more specific embodiments, the at least one further carbon and/or the at least one binder is dissolved in an aqueous medium. In some embodiments, the silicon-carbon composite mixture is composed such that the silicon-carbon composite mixture has an electron density ranging from 1.05 g/cm³ to 1.5 g/cm³, or from 1.1 g/cm³ and 1.3 g/cm³.

In some embodiments, the silicon-carbon composite mixture has an electrical conductivity ranging from 0.3 S/cm to 2 S/cm, or from 0.5 S/cm and 1.2 S/cm. In some embodiments, the carbon is a hard carbon material, a graphitic carbon, or a metal oxide. In certain more specific embodiments, the binder is configured to bind the porous carbon and the silicon content of the first silicon-carbon composite, the porous carbon and the silicon-carbon portion of the second silicon-carbon composite and/or the first silicon-carbon composite and the second silicon-carbon composite. In more specific embodiments, the silicon-carbon composite mixture comprises at least one additional binder. In some embodiments, the binder or additional binder is a styrene-butadiene gum/carboxymethylcellulose (CMC/SBR) mixture, a polyacrylic acid (PAA) and/or a lithium polyacrylic (LiPAA) or a sodium polyacrylic (NaPAA).

One specific embodiment provides a method of manufacturing an anode electrode comprising a silicon-carbon composite mixture according to any one of the embodiments described herein, comprising the steps:
a) mixing the silicon-carbon composite mixture with at least one carbon, to create a mixture,
b) combining the mixture and a binder solution in a twin screw extruder, thereby forming an electrode paste,
c) applying the electrode paste to a conductor thereby producing at least one electrode,
d) drying the at least one electrode at a temperature of 100° C. to 140° C.

One embodiment provides an electrochemical storage device, especially formed as a lithium-ion-battery, comprising:
a) at least one anode electrode, according to any one of embodiments described herein;
b) at least one electrode, formed as a cathode, comprising a transition metal oxide;
c) a separator disposed between the cathode and the anode; and
d) an electrolyte comprising lithium ions.

One additional embodiment provide an anode electrode comprising the silicon-carbon mixture of any one of the embodiments described herein.

One embodiment provides usage of a silicon-carbon composite mixture in an anode electrode, the silicon-carbon composite material comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm;
c) 10% to 90% by mass of the first silicon-carbon composite material and 10% to 90% by mass of the second silicon-carbon composite material.

In some embodiments, the silicon-carbon composite mixture has a surface area of less than 30 m²/g. In some more specific embodiments, the silicon-carbon composite mixture has E greater than 0.01, wherein E is defined as 1−(density for composite mixture)/(mass averaged density for individual fractions), wherein density is the electrode density as measured in an electrode composed of 70 wt % composite, 20 wt % graphite, and 2 wt % Super C65, and 8% PAA. In some more specific embodiments, the silicon-carbon composite mixture has E greater than 0.01, wherein E is defined as 1−(tap density for composite mixture)/(mass averaged tap density for individual fractions). In some embodiments, for the determination of E measurement of electrode properties of the silicon-carbon composite mixture and the individual fractions comprising each mode are measured under otherwise identical conditions. In some embodiments, E is greater than 0.05. In certain embodiments, E is greater than 0.1.

One embodiment provides usage of a silicon-carbon composite mixture in an anode electrode, the silicon-carbon composite material comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm; and
c) 10% to 90% by mass of the first silicon-carbon composite material and 10% to 90% by mass of the second silicon-carbon composite material.

In some embodiments, the silicon-carbon composite mixture has a surface area of less than 30 m²/g. In some more specific embodiments, the silicon-carbon composite mixture has E greater than 0.01, wherein E is defined as 1−(density for composite mixture)/(mass averaged density for individual fractions), wherein density is the electrode density as measured in an electrode composed of 70 wt % composite, 20 wt % graphite, and 2 wt % Super C65, and 8% PAA. In some more specific embodiments, the silicon-carbon composite mixture has E greater than 0.01, wherein E is defined as 1−(tap density for composite mixture)/(mass averaged tap density for individual fractions). In some more specific embodiments, E is greater than 0.05. In certain embodiments, E is greater than 0.1.

One additional embodiment provides usage of an anode electrode according to anyone of the embodiments described herein in an electrochemical storage device.

The carbon materials produced according to the compositions and methods described herein have improved electrochemical properties and are particularly applicable to a variety of electrical devices, especially Li-ion batteries.

According to one aspect of the present disclosure a multimodal silicon-carbon composite (silicon-carbon composite) material for an electrode is provided. The multimodal silicon-carbon composite material comprises a first silicon-carbon composite, wherein first silicon-carbon composite includes a porous carbon and a silicon content between 30% to 70%, wherein the first silicon-carbon composite comprises a first fraction with a particle size distribution with a Dv50=7 μm to 20 μm; and comprises at least one additional silicon-carbon composite, wherein the additional silicon-carbon composite includes at least one porous carbon and a silicon content of 30% to 70%, the additional silicon-carbon composite having a further fraction with a particle size distribution with Dv50=2 μm to 6 μm, wherein in the multimodal silicon-carbon composite comprises a first fraction of the first silicon-carbon composite in a proportion of 70% to 90% and the additional silicon-carbon composite has a proportion of 10% to 30%.

In some embodiments, the mass fraction of the first fraction of the first silicon-carbon composite has a proportion of 10% to 90%, for example 20% to 90%, for example 30% to 90%, for example 40% to 90%, for example 50% to 90%, for example 60% to 90%. Correspondingly in some embodiments, the mass fraction of the additional silicon-carbon composite has a proportion of 10% to 90%, for example 10% to 80%, for example 10% to 70%, for example 10% to 60%, for example 10% to 50%, for example 10% to 40%.

In some embodiments, the mass fraction of the first fraction of the first silicon-carbon composite has a proportion of 10% to 50%, for example 20% to 50%, for example 30% to 50%, for example 40% to 50%. Correspondingly, in some embodiments, the mass fraction of the further fraction of the additional silicon-carbon composite has a proportion of 50% to 90%, for example 50% to 80%, for example 50% to 70%, for example 50% to 60%.

Typically, the silicon in a porous carbon is introduced into the pores of the porous carbon by means of a chemical vapor infiltration (CVI) reaction of silicon-containing gas such as monosilane, e.g., silicon hydrogen (SiH₄). Descriptions of such processes are described in US Publication No. 2017/0170477, the full disclosure of which is hereby incorporated by reference in its entirety for all purposes.

Thus, the present subject matter relates to a particle size composition of a composite material. In this context, multimodal means that the composite material comprises at least two fractions. A respective fraction is a respective predetermined range of particle sizes of a particle size distribution.

The term carbon material refers to a material or substance consisting of carbon or at least comprising carbon. In this regard, a carbon material may comprise high purity, amorphous and crystalline materials. A carbon material may be an activated carbon, a pyrolyzed dried polymer gel, a pyrolyzed polymer cryogel, a pyrolyzed polymer xerogel, a pyrolyzed polymer aerogel, an activated dried polymer gel, an activated polymer cryogel, an activated polymer xerogel, an activated polymer aerogel, or a combination thereof. In a further embodiment, a carbon is producible by a pyrolysis of coconut shells or other organic waste. In this regard, a polymer is a molecule comprising two or more repeating structural units.

A porous carbon, also known as a porous carbon material, offers the advantage that it is usually easy to produce, usually has low impurities and a large pore volume. As a result, a porous carbon exhibits good electrical conductivity and high mechanical and chemical stability. In one embodiment, the carbon material has a high micropore volume ratio.

Typically, the porous carbon has a pore space, also referred to as a pore volume, wherein the pore space is a group of voids (pores) in the carbon that is fillable with a gas or fluid.

In this regard, properties of porous carbon, and manufacturing methods are described in the prior art, for example US Publication No. 2017/0015559, the full disclosure of which is hereby incorporated by reference in its entirety for all purposes.

The Si portion may be a pure silicon or a material composition comprising silicon. For example, the Si portion may be at least one alloy. An alloy may be a silicon-titanium alloy (Si-Ti), a silicon iron alloy (Si—Fe), a silicon nickel alloy (Si—Ni). In a further embodiment, the Si portion may consist of P-dopants, As-dopants or N-dopants. A P-dopant is usually a phosphorus dopant, an As-dopant is usually an arsenic dopant and an N-dopant is usually a nitrogen dopant.

The silicon content of the total mass of the multimodal silicon-carbon composite material is usually between 10% and 90%, for example 20% to 80%, for example 30% to 70%, for example 40% and 60%.

A binder is a binding agent or binding material. A binder thus refers to a material that can hold together individual components, in particular particles, of a substance, for example a carbon. A binder is typically arranged such that when particles are brought together with a corresponding binder, a cohesive mass is formed which can be further shaped into a new form.

In one embodiment, a binder is a styrene-butadiene gum/carboxymethylcellulose (CMC/SBR) blend, a polyacrylic acid (PAA) and/or a lithium polyacrylic (LiPAA) or a sodium polyacrylic (NaPAA). In an alternative embodiment, the binder is formed as a fluoropolymer such as a polytetrafluoroethylene (PTFE), a perfluoroalkoxy polymer resin (PFA), a fluorinated ethylene propylene (FEP), a polyethylene tetrafluoroethylene (ETFE), a polyvinyl fluoride (PVF), a polyethylene chlorotrifluoroethylene (ECTFE), a (polyvinylidene fluoride (PCDF), a (polychlorotrifluoroethylene (PCTFE), a trifluoroethanol, or combinations of at least one of these materials with at least one other material. In a further embodiment, a binder is a polyimide or a copolymer of polyacrylic acid and styrene-butadiene.

The present disclosure offers the advantage that the bimodal distribution of the composite enables a higher packing density and improved electrical conductivity of an anode electrode.

In a further embodiment, the multimodal silicon-carbon composite comprises at least one further carbon and/or at least one further binder. This results in the advantage that carbon increases the conductivity of the electrode and thus provides improved conductivity. The at least one further binder further supports the mechanical stability. A further carbon may be a hard carbon material or a graphitic carbon or a metal oxide.

In one embodiment, the at least one further carbon and/or the at least one further binder is dissolved in an aqueous medium.

In a further embodiment, the multimodal silicon-carbon composite material is composed such that the silicon-carbon composite material has an electron density of 1.05 g/cm³ to 1.5 g/cm³, in particular between 1.1 g/cm³ and 1.3 g/cm³. This offers the advantage that the particles comprise better contact with each other and thus the conductivity of the resulting electrode is improved.

In a further embodiment, the multimodal silicon-carbon composite material is composed in such a way that the multimodal silicon-carbon composite material has a BET surface area (according to Brunauer Emmett Teller measurement) of between 4 m³/g and 30 m²/g, in particular between 8 m²/g and 20 mg²/g. The BET surface area according to the BET measurement is a term for an analytical method for determining the size of surfaces, in particular porous solids, by means of gas adsorption.

In a further embodiment, the BET surface area is between 5 m²/g and 25 m²/g. In a further embodiment, the silicon-carbon composite material has an electrical conductivity of 0.3 S/cm to 2 S/cm, in particular between 0.5 S/cm and 1.2 S/cm.

This offers the advantage that the resistance of the electrode is reduced, thus allowing a faster reaction of the Li-ions with the multimodal Si—C-composite material. Hence, a charging speed of the lithium-ion cell may be increased.

In one embodiment, the carbon is a hard carbon material, a graphitic carbon or a metal oxide. For example, the metal oxide is a silicon oxide (SiO₂). Alternatively, a metal oxide is a titanium oxide (TiO₂), a tin oxide (SnO₂) or other metal oxide. A hard carbon material is a non-graphitizable carbon material. A hard carbon offers the advantage that it remains amorphous at elevated temperatures (typically >1500° C., whereas a “soft” carbon crystallizes and becomes graphite.

In one embodiment, the carbon may be a modified hard carbon. A modified hard carbon is a composite material comprising both a carbon, in particular a hard carbon, and a lithium alloy material. A lithium alloy material may be silicon, tin, germanium, nickel, aluminum, manganese, alumina (AI₂O₃), titanium, titanium oxide, sulfur, molybdenum, arsenic, gallium, phosphorus, selenium, antimony, bismuth, tellurium or indium or any other metal or metalloid capable of absorbing lithium.

In a further embodiment, the binder is configured to bind the porous carbon and the Si portion of the first silicon-carbon composite, the porous carbon and the silicon-carbon portion of the further silicon-carbon composite, and/or the first silicon-carbon composite and the further silicon-carbon composite.

In a further embodiment, the binder is adapted to bind further materials to at least one of the respective silicon-carbon composites. Thus, a binder is generally arranged to hold together the components of the multimodal silicon-carbon composite material and optionally further carbon materials of the electrode which may be formed as an anode.

In one further embodiment, the multimodal silicon-carbon composite material comprises at least two binders, wherein a first binder is arranged to bind the porous carbon and the silicon-carbon portion of the first silicon-carbon composite and the porous carbon and the Si portion of the second silicon-carbon composite, and wherein the at least one further binder is arranged to bond the first silicon-carbon composite to the second silicon-carbon composite.

Optionally, the silicon-carbon composite material comprises at least one further binder adapted to bond the first material component and the at least one further material component together.

According to a further aspect of the present disclosure an anode comprising at least one silicon-carbon composite multimodal material described above is provided.

In accordance with a further aspect of the present disclosure a method of manufacturing a silicon-carbon composite material described above is provided. In a first step, a porous carbon scaffold material is produced. In preferred embodiments, the carbon scaffold is prepared according to the aforementioned US Publication No. 2017/0015559. In preferred embodiments, the porous carbon scaffold carbon is an amorphous carbon comprising nitrogen. The use of nitrogen (N) improves the conductivity of the amorphous carbon. In some embodiments a polymer gel is pyrolyzed in nitrogen at a temperature of 700° C. to 950° C. to obtain a silicon-carbon composite material.

In preferred embodiments, the porous carbon scaffold comprises micropores, mesopores, and/or macropores, wherein micropores are defined as pores with diameter less than 2 nm, mesopores are defined as pores with diameter of 2 nm to 50 nm, and mesopores are defined as pores with diameter greater than 50 nm. As used herein, the percentage “microporosity,” “mesoporosity” and “macroporosity” refers to the percent of micropores, mesopores and macropores, respectively, as a percent of total pore volume. For example, a carbon scaffold having 90% microporosity is a carbon scaffold where 90% of the total pore volume of the carbon scaffold are micropores.

In a further step, the silicon-carbon composite material is comminuted by grinding to produce at least two silicon-carbon composites wherein each of the two silicon-carbon composites has a unique average particle size. In particular, one of the at least two silicon-carbon composites comprises a particle size distribution with a percentile of Dv50=6 μm to 20 μm and a second silicon-carbon composite comprises a particle size distribution with a percentile of Dv50=1 μm to 6 μm. Such comminution can be accomplished as known in the art, for example abrasion type milling processes such particle size reduction using a hammer mill, ball mill, jet mill, or other abrasion type mill.

The two or more fractions of silicon-carbon composites each comprise a porous carbon scaffold with certain properties, for example properties as disclosed in the aforementioned US Publication No. 2017/0170477. Exemplary properties are presented in Table 1.

TABLE 1
Exemplary carbon scaffold properties.

| Property | Exemplary Values |
|---|---|
| Total Pore | 0.1-1.5 cm³/g, 0.2-1.2 cm³/g, 0.3-1.1 cm³/g, 0.4-1.0 cm³/g, 0.4-1.0 |
| Volume | cm³/g, 0.5-1.0 cm³/g, 0.6-1.0 cm³/g, 0.5-0.9 cm³/g, 0.4-1.0 |
| | cm³/g, >0.1 cm³/g, >0.2 cm³/g, >0.4 cm³/g, >0.5 cm³/g, >0.6 |
| | cm³/g, >0.7 cm³/g >0.8 cm³/g; >0.9 cm³/g |
| Percentage of | >20%/>30%/>30%, <10/>30/>30, <5/>30/>30, <5/>40/>40, |
| microporosity/ | <1/>40/>40, <10/>70/>20, <10/>20/>70, >10/>10/>80, |
| mesoporosity/ | <10/>80/>10, <5/>70/>20, <5/>20/>70, <5/>5/>80, <5/>80/>10, |
| macroporosity | >80%/<20%/<20%, >70/<30/<10, >70/<30/<5, |
| expressed as | >70/<20/<10, >70/<10/<10, >70/<10/<5, >70/<5/<5, >80/<20/<10, |
| percentage of | >80/<20/<5, >80/<20/<1, >80/<10/<10, >80/<10/<5, >80/<10/<1, |
| total pore | >90/<10/<10, >90/<10/<5, >90/<10/<1, >90/<5/<1, >95/<5/<5, |
| volume | >90/<5/<1 |
| Dv50 for each | First fraction: 2 to 4 micron, 2 to 6 micron, 2 to 8 micron, 2 to 10 |
| Fraction | micron, 2 to 12 micron, 2 to 14 micron, 2 to 16 micron, 2 to 20 |
| | micron, 3 to 6 micron, 3 to 8 micron, 3 to 10 micron, 3 to 12 micron, |
| | 3 to 14 micron, 3 to 16 micron, 3 to 18 micron, 3 to 20 micron, 4 to |
| | 6 micron, 4 to 8 micron, 4 to 10 micron, 4 to 12 micron, 4 to 14 |
| | micron, 4 to 16 micron, 4 to 18 micron, 4 to 20 micron, 5 to 6 |
| | micron, 5 to 8 micron, 5 to 10 micron, 5 to 12 micron, 5 to 14 |
| | micron, 5 to 16 micron, 5 to 18 micron, 5 to 20 micron, 6 to 8 |
| | micron, 6 to 10 micron, 6 to 12 micron, 6 to 14 micron, 6 to 16 |
| | micron, 6 to 18 micron, 6 to 20 micron, 7 to 10 micron, 7 to 12 |
| | micron, 7 to 14 micron, 7 to 16 micron, 7 to 18 micron, 7 to 20 |
| | micron, 8 to 10 micron, 8 to 12 micron, 8 to 14 micron, 8 to 16 |
| | micron, 8 to 18 micron, 8 to 20 micron, 10 to 12 micron, 10 to 14 |
| | micron, 10 to 16 micron, 10 to 18 micron, 10 to 20 micron, 12 to 14 |
| | micron, 12 to 16 micron, 12 to 18 microns, 12 to 20 microns. |
| | Second fraction: 0.1 to 1 micron, 0.1 to 2 micron, 0.1 to 3 micron, |
| | 0.1 to 4 micron, 0.1 to 5 micron, 0.1 to 6 micron, 0.1 to 7 micron, |
| | 0.5 to 1 micron, 0.5 to 2 micron, 0.5 to 3 micron, 0.5 to 4 micron, |
| | 0.5 to 5 micron, 0.5 to 6 micron, 1 to 2 micron, 1 to 3 micron, 1 to 4 |
| | micron, 1 to 5 micron, 1 to 6 micron, 2 to 3 micron, 2 to 4 micron, 2 |
| | to 5 micron, 2 to 6 micron, 3 to 4 micron, 3 to 5 micron, 3 to 6 |
| | micron, 4 to 5 micron, 4 to 6 micron, 5 to 6 micron. |

In a further step, the at least two carbon scaffold fractions are subject to the CVI process to impregnate silicon into pores of the porous carbon. Descriptions of such processes are described in the aforementioned US Publication No. 2017/0170477.

It is further an object of the present disclosure to provide a method of manufacturing an anode electrode comprising a silicon-carbon composite mixture described above.

In a first step, the method of manufacturing comprises mixing the Si—C-composite material with at least one carbon. In a further step, the mixture and a binder solution are combined in a twin screw extruder to form an electrode paste. A binder solution in this case is typically a binder dissolved in an aqueous solution. In a further step, the electrode paste is applied to a current conductor to produce at least one electrode. In a further step, the at least one electrode is dried at a temperature of 100° C. to 140° C.

It is further an object of the present disclosure to provide an electrical energy storage device, in particular a lithium ion battery, comprising at least one anode electrode comprising a multimodal silicon-carbon composite material described above, at least one cathode electrode comprising a transition metal oxide, a separator disposed between the cathode electrode and the anode electrode, and an electrolyte comprising lithium ions.

The multimodal silicon-carbon composite material, when processed into an electrode as described herein, provides for surprising and unexpected results. For example, certain beneficial properties of the electrode comprising the multimodal silicon-carbon composite material exceed the properties of the mass averaged properties of the corresponding individual fractions comprising the multimodal silicon-carbon composite material. Such properties include, but are not limited to, physicochemical properties such as density, and electrochemical properties such as conductivity. The latter also provides for the surprising and unexpected result of increased rate capability for the energy storage device comprising the electrode comprising the multimodal silicon-carbon composite material.

Another improvement for the multimodal silicon-carbon composite material is observed in an increase in the C-rate capability of the electrodes prepared with the multimodal silicon-carbon composite material compared to the measurement of the electrode properties of the individual fractions. The improvement for the charge and discharge C-rate is in the range of 3 to 30%, more preferably in the range of 5 to 15%. In order to measure the C-rate performance, a similar electrode loading and electrode preparation was set. The loading for the silicon-carbon composite material and the individual fractions was chosen to be 4.0 mAh/cm². The electrode for this measurement was prepared by mixing the active materials with carbon materials and a binder dissolved in an aqueous solution. The ratio of the mixture was set to 70 wt % active material, 20 wt % graphite (KSL6, Imerys) and 2 wt % Super C65 (Imerys) and 8% PAA dissolved in water. The active material for this experiment was either the multimodal silicon-carbon composite or the individual fractions. The electrolyte for this measurement was selected to be 1M LiPF₆ dissolved in a mixture of fluoroethylene carbonate and diethyl carbonate in a ratio of 1:4. For the experiments the current for the C-rate was defined to be 1800 mAh for the 1C rate of the electrodes.

Accordingly, the electrode comprising the silicon-carbon composite material comprises one or more property with an enhancement factor, E, wherein E=1−(value for composite material)/(mass averaged value for individual fractions). For the determination of E, measurement of electrode properties of the multimodal silicon-carbon composite material and the individual fractions comprising each mode are measured under otherwise identical conditions.

In some embodiments, the slurry mixture is applied to a current collector as known in art following a sequence of coating, drying, and calendaring. The extent of calendaring can be expressed as the difference between the initial electrode thickness and final electrode thickness divided by the initial electrode thickness express as percentage. For example, for an initial electrode thickness (i.e., before calendaring) of 50 microns and a final electrode thickness (i.e., after calendaring) of 40 microns, the extent of calendaring is 20%. In some embodiments, the % calendaring is 10% to 50%, for example 15% to 40%, for example 15% to 30%. In still further embodiments the final electrode comprises a first slurry mixture comprising a first Si—C composite having a first average particle size applied to a current collector and optionally dried and calendared. The electrode further comprises a second slurry mixture comprising a second Si—C composite having a second average particle size which is applied to the current collector and optionally dried and calendared. This electrode layering process is optionally repeated with additional or the two or more Si—C composites to create a layered electrode.

In certain embodiments, E for one or more electrode properties is greater than 0.01, for example greater than 0.02, for example greater than 0.05, for example greater than 0.1, for example greater than 0.15, for example greater than 0.2, for example greater than 0.3, for example greater than 0.4, for example greater than 0.5, for example greater than 0.6, for example greater than 0.8, for example greater than 1.0, for example greater than 1.2, for example greater than 1.5, for example greater than 2.0.

### Example 1. Production of Silicon-Carbon Composite Material by CVI

The properties of the carbon scaffold (Carbon Scaffold 1) employed for producing the silicon-carbon composite is presented in Table 2. Employing Carbon Scaffold 1, the silicon-carbon composite (Silicon-Carbon Composite 1) is produced by CVI as follows:

A mass of 0.2 grams of amorphous porous carbon is placed into a 2 in.×2 in. ceramic crucible then positioned in the center of a horizontal tube furnace. The furnace is sealed and continuously purged with nitrogen gas at 500 cubic centimeters per minute (ccm). The furnace temperature is increased at 20° C./min to 450° C. peak temperature where it is allowed to equilibrate for 30 minutes. At this point, the nitrogen gas is shutoff and then silane and hydrogen gas are introduced at flow rates of 50 ccm and 450 ccm, respectively for a total dwell time of 30 minutes. After the dwell period, silane and hydrogen are shutoff and nitrogen is again introduced to the furnace to purge the internal atmosphere. Simultaneously the furnace heat is shutoff and allowed to cool to ambient temperature. The completed Si—C material is subsequently removed from the furnace.

TABLE 2
Description of carbon scaffold employed for Example 1.

| Carbon | | Pore | % | % | % |
|---|---|---|---|---|---|
| Scaffold | Surface | Volume | Micro- | Meso- | Macro- |
| # | Area (m²/g) | (cm³/g) | pores | pores | pores |
| 1 | 1710 | 0.762 | 93.1 | 6.8 | 0.1 |

### Example 2. Analysis of Various Silicon-Composite Materials

A variety of carbon scaffold materials are employed, and the carbon scaffold materials are characterized by nitrogen sorption gas analysis to determine specific surface area, total pore volume, and fraction of pore volume comprising micropores, mesopores, and macropores. The characterization data for the carbon scaffold materials is presented in Table 3, namely the data for carbon scaffold surface area, pore volume, and pore volume distribution (% micropores, % mesopores, and % macropores), all as determined by nitrogen sorption analysis.

TABLE 3
Properties of various carbon scaffold materials.

| Carbon | | Pore | % | % | % |
|---|---|---|---|---|---|
| Scaffold | Surface | Volume | Micro- | Meso- | Macro- |
| # | Area (m²/g) | (cm³/g) | pores | pores | pores |
| 1 | 1710 | 0.762 | 93.1 | 6.8 | 0.1 |
| 2 | 1744 | 0.72 | 97.2 | 2.7 | 0.1 |
| 3 | 1581 | 0.832 | 69.1 | 30.9 | 0.1 |
| 4 | 1710 | 0.817 | 80.1 | 19.9 | 0 |
| 5 | 1835 | 0.9 | 82.2 | 17.8 | 0 |
| 6 | 1475 | 1.06 | 52.4 | 47.6 | 0 |
| 7 | 453 | 0.5 | 3.9 | 91.1 | 5.1 |
| 8 | 787 | 2.284 | 0 | 59.1 | 40.9 |
| 9 | 1713 | 0.76 | 91 | 9 | 0 |
| 10 | 1746 | 0.7552 | 95 | 5 | 0 |

The carbons scaffold sample as described in Table 4 are employed to produce a variety of silicon-carbon composite materials employing the CVI methodology in a static bed configuration as generally described in Example 1. These silicon-carbon samples are produced employing a range of process conditions: silane concentration 1.25% to 100%, diluent gas nitrogen or hydrogen, carbon scaffold starting mass 0.2 g to 700 g.

The surface area for the silicon-carbon composites is determined. The silicon-carbon composites are also analyzed by TGA to determine silicon content. Silicon-carbon composite materials are also tested in half-cell coin cells. The anode for the half-cell coin cell can comprise 60-90% silicon-carbon composite, 5-20% Na-CMC (as binder) and 5-20% Super C45 (as conductivity enhancer), and the electrolyte can comprise 2:1 ethylene carbonate: diethylene carbonate, 1 M LiPF₆ and 10% fluoroethylene carbonate. The half-cell coin cells can be cycled at 25° C. at a rate of C/5 for 5 cycles and then cycled thereafter at C/10 rate. The voltage can be cycled between 0 V and 0.8 V, alternatively, the voltage can be cycled between 0 V and 1.5 V. From the half-cell coin cell data, the maximum capacity can be measured, as well as the average Coulombic efficiency (CE) over the range of cycles from cycle 7 to cycle 20. Physicochemical and electrochemical properties for various silicon-carbon composite materials are presented in Table 4.

TABLE 4
Properties of various silicon-carbon materials.

| Silicon- | | | | | |
|---|---|---|---|---|---|
| Carbon | Carbon | Surface | | Max | |
| Composite | Scaffold | Area | Si content | Capacity | Average CE |
| # | # | (m²/g) | (%) | (mAh/g) | (7-20) |
| 1 | 1 | 7 | 45.0 | 1433 | 0.9981 |
| 2 | 1 | 7 | 45.4 | 1545 | 0.9980 |
| 3 | 1 | 6 | 45.8 | 1510 | 0.9975 |
| 4 | 2 | 3.06 | 50.1 | 1665 | 0.9969 |
| 5 | 2 | 1.96 | 51.3 | 1662 | 0.9974 |
| 6 | 3 | 140 | 43.1 | 832 | 0.9941 |
| 7 | 2 | 1.61 | 48.7 | 1574 | 0.9977 |
| 8 | 2 | 2 | 48.5 | 1543 | 0.9972 |
| 9 | 1 | 8 | 46.3 | 1373 | 0.9976 |
| 10 | 4 | 44 | 51.2 | 1614 | 0.9975 |
| 11 | 5 | 94 | 48.9 | 1455 | 0.9969 |
| 12 | 6 | 61 | 52.1 | 2011 | 0.9869 |
| 13 | 7 | 68.5 | 34.6 | 1006 | 0.9909 |
| 14 | 8 | 20 | 74 | 2463 | 0.9717 |
| 15 | 8 | 149 | 57.7 | 1892 | 0.9766 |
| 16 | 8 | 61.7 | 68.9 | 2213 | 0.9757 |
| 17 | 9 | 11 | 46.1 | 1675 | 0.9990 |
| 18 | 9 | 11 | 46.7 | 1739 | 0.9985 |
| 19 | 9 | 15.1 | 46.8 | 1503 | 0.9908 |
| 20 | 9 | 4.1 | 47.9 | 1790 | 0.9953 |
| 21 | 9 | 5 | 48.1 | 1861 | 0.9962 |

### Example 3. Particle Size Distribution for Various Carbon Scaffold Materials

The particle size distribution for the various carbon scaffold materials is determined by using a laser diffraction particle size analyzer as known in the art. Table 5 presents the particle size distribution data, specifically the Dv1, Dv10, Dv50, and Dv90, and Dv100.

TABLE 5
Properties of various carbon scaffold materials.

| Carbon Scaffold | |
|---|---|
| # | Particle Size Characteristics |
| 1 | Dv1 = 1.2 μm, Dv10 = 2.5 μm, Dv50 = 6.9 μm, |
| | Dv90 = 11.5 μm, Dv100 = 20.1 μm |
| 2 | Dv1 = 1.09 μm, Dv10 = 3.4 μm, Dv50 = 7.67 μm, |
| | Dv90 = 13.3 μm, Dv100 = 17.8 μm |
| 4 | Dv1 = 0.81 μm, Dv10 = 1.9 μm, Dv50 = 6.4 μm, |
| | Dv90 = 16.6 μm, Dv100 = 26.5 μm |
| 5 | Dv1 = 0.62 μm, Dv10 = 1.1 μm, Dv50 = 4.2 μm, |
| | Dv90 = 15.8 μm, Dv100 = 29.8 μm |
| 8 | Dv1 = 1.3 μm, Dv10 = 3.7 μm, Dv50 = 16 μm, |
| | Dv90 = 35.2 μm, Dv100 = 50.7 μm |
| 9 | Dv1 = 1.2 μm, Dv10 = 2.7 μm, Dv50 = 7.6 μm, |
| | Dv90 = 12.3 μm, Dv100 = 20.7 μm |

### Example 4. Blending of Various Silicon-Carbon Composite Materials

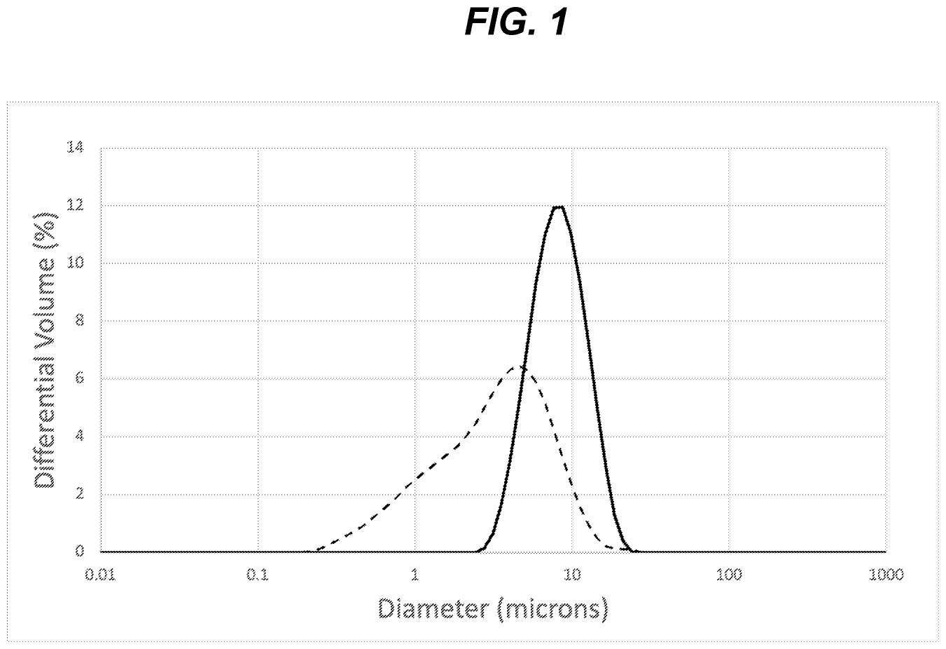

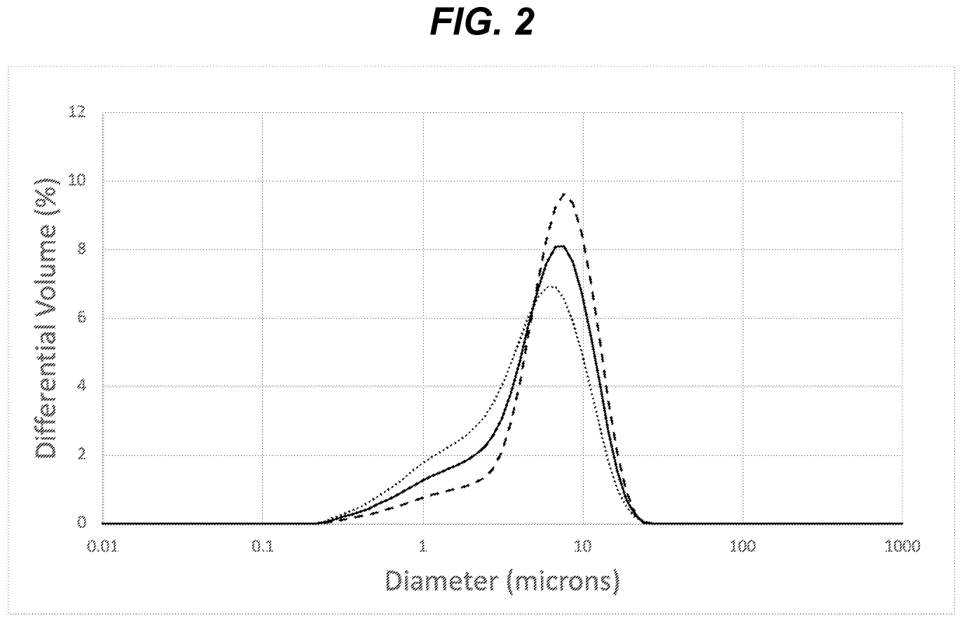

For this example, two silicon-carbon composite materials are blended at various ratios. The first material, denoted as Silicon-Carbon Composite 22, comprises a particle size distribution comprising Dv1, Dv10, Dv50 Dv90, and Dv99 or 0.35 microns, 0.76 microns, 3.28 microns, 6.30 microns, and 8.28 microns, respectively. The second material, denoted as Silicon-Carbon Composite 23, comprises a particle size distribution comprising Dv1, Dv10, Dv50 Dv90, and Dv99 or 4.23 microns, 5.73 microns, 8.80 microns, 13.0 microns, and 15.98 microns, respectively. The Particle size distribution of these two materials is depicted in FIG. 1. These two materials are blended at various mass ratios, for example 30% Silicon-Carbon Composite 22 with 70% Silicon-Carbon Composite 23, alternatively 50% Silicon-Carbon Composite 22 with 50% Silicon-Carbon Composite 23, alternatively 70% Silicon-Carbon Composite 22 with 30% Silicon-Carbon Composite 23, and the corresponding particle size distributions are presented in FIG. 2.

### Example 5. Multiple Blended Silicon-Carbon Composite Materials

For this Example 5, two silicon-carbon composite materials were blended at various ratios. The first material denoted in Table 5 as Silicon-Carbon Composite 24 comprises a particle size distribution comprising Dv1, Dv10, Dv50 Dv90, and Dv99 or 0.6 microns, 1.0 microns, 2.3 microns, 5.3 microns, and 7.9 microns, respectively. The second material denoted in Table 6 as Silicon-Carbon Composite 25 comprises a particle size distribution comprising Dv1, Dv10, Dv50 Dv90, and Dv99 or 1.2 microns, 4.1 microns, 8.2 microns, 14.6 microns, and 20.8 microns, respectively. The materials 24 and 25 were blended at various mass ratios. For instance, Blend 1 comprises 10% of Composite 24 and 90% Composite 25. Blend 2 comprises 90% of Composite 24 and 10% of Composite 25. Finally, Blend 3 comprises 50% Composite 24 and 50% Composite 25.

TABLE 6
Properties of various carbon scaffold materials.

| | Tap | Bulk | |
|---|---|---|---|
| | Density | Density | |
| Composite | (g/mL) | (g/cc) | E |
| 24 | 0.44 | 0.25 | — |
| 25 | 1.64 | 0.52 | — |
| Blend 1 | 0.95 | 0.49 | 0.68 |
| Blend 2 | 0.50 | 0.21 | 0.63 |
| Blend 3 | 0.66 | 0.30 | 0.71 |

### Embodiments

Embodiment 1. A silicon-carbon composite mixture comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm; and
c) 10% to 90% by mass of the first silicon-carbon composite material and 10% to 90% by mass of the second silicon-carbon composite material.

Embodiment 2. The silicon-carbon composite mixture of Embodiment 1, wherein the silicon-carbon composite mixture has a surface area of less than 30 m²/g.

Embodiment 3. The silicon-carbon composite mixture of Embodiments 1 or 2, wherein E greater than 0.01, wherein E is defined as 1−(density for composite mixture)/(mass averaged density for individual fractions), wherein density is the electrode density as measured in an electrode composed of 70 wt % composite, 20 wt % graphite, and 2 wt % Super C65, and 8% PAA.

Embodiment 4. The silicon-carbon composite mixture of Embodiment 3, wherein for the determination of E, measurement of electrode properties of the silicon-carbon composite mixture and the individual fractions comprising each mode are measured under otherwise identical conditions.

Embodiment 5. A silicon-carbon composite mixture comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm;
c) 10% to 90% by mass of the first silicon-carbon composite material and 10% to 90% by mass of the second silicon-carbon composite material;
d) a surface area of less than 30 m²/g;
e) E greater than 0.01, wherein E is defined as 1−(tap density for composite mixture)/(mass averaged tap density for individual fractions); and
f) for the determination of E, measurement of tap density of the silicon-carbon composite mixture and the individual fractions comprising each mode are measured under otherwise identical conditions.

Embodiment 6. A silicon-carbon composite mixture comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm;
c) 10% to 90% by mass of the first silicon-carbon composite material and 10% to 90% by mass of the second silicon-carbon composite material;
d) a surface area of less than 30 m²/g; and
e) E greater than 0.01, wherein E is defined as 1−(conductivity for composite material)/(mass averaged conductivity for individual fractions).

Embodiment 7. The silicon-carbon composite mixture of any one of Embodiments 1-6, wherein E is greater than 0.05.

Embodiment 8. The silicon-carbon composite mixture of any one of Embodiments 1-6, wherein E is greater than 0.1.

Embodiment 9. A method to manufacture a silicon-carbon composite mixture comprising the steps:
a) providing a porous carbon scaffold
b) comminution the porous carbon scaffold to produce at least two particulate fractions, comprising:
   i. a first porous carbon composite material comprising a plurality of particles with Dv50=6 μm to 20 μm;
   ii. a second porous carbon composite material comprising a particle size distribution with Dv50=1 μm to 6 μm;
c) impregnation of silicon into the pores of the at least two particulate fractions of porous carbon composite materials by chemical vapor infiltration to produce a first silicon-carbon composite and a second silicon-carbon composite; and d) blending of the first silicon-carbon composite and the second silicon-carbon composite material.

Embodiment 10. The silicon-carbon composite mixture of any one of Embodiments 1-9, wherein the mixture comprises the first fraction of the first silicon-carbon composite with a proportion of 60% to 90% by weight and the second silicon-carbon composite with a proportion of 10% to 40% by weight.

Embodiment 11. The silicon-carbon composite mixture of any one of Embodiments 1-10, wherein the mixture comprises the first fraction of the first silicon-carbon composite with a proportion of 70% to 90% by weight and the second silicon-carbon composite with a proportion of 10% to 30% by weight.

Embodiment 12. A method to manufacture a silicon-carbon composite mixture comprising the steps:
a) providing a porous carbon scaffold
b) comminution the porous carbon scaffold to produce at least two particulate fractions, comprising:
   i. a first porous carbon composite material comprising a plurality of particles with Dv50=6 μm to 20 μm;
   ii. a second porous carbon composite material comprising a particle size distribution with Dv50=1 μm to 6 μm;
c) impregnation of silicon into the pores of the at least two particulate fractions of porous carbon composite materials by chemical vapor infiltration; and
d) applying a coating onto the surface of the at least two particulate fractions of the porous silicon-carbon composite by chemical vapor deposition; and
e) blending of the first particulate silicon-carbon composite material and the second particulate silicon-carbon composite material.

Embodiment 13. An anode electrode, comprising a silicon-carbon composite mixture comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm; and
c) 10% to 90% by mass of the first silicon-carbon composite material and 10% to 90% by mass of the second silicon-carbon composite material.

Embodiment 14. The anode electrode of Embodiment 13, wherein the surface area of the silicon-carbon composite mixture is less than 30 m²/g.

Embodiment 15. The anode electrode of Embodiment 13 or 14, wherein the anode electrode has a density comprising E greater than 0.01, wherein E is defined as 1−(density for composite mixture)/(mass averaged density for individual fractions), wherein density is the electrode density as measured in an electrode composed of 70 wt % composite, 20 wt % graphite, and 2 wt % Super C65, and 8% PAA.

Embodiment 16. The anode electrode of Embodiment 15, wherein for the determination of E, measurement of electrode properties of the silicon-carbon composite mixture and the individual fractions comprising each mode are measured under otherwise identical conditions.

Embodiment 17. The anode electrode of Embodiment 13 or 14, wherein the anode electrode has a density comprising E greater than 0.01, wherein E is defined as 1−(tap density for composite mixture)/(mass averaged tap density for individual fractions), wherein density is the electrode density as measured in an electrode composed of 70 wt % composite, 20 wt % graphite, and 2 wt % Super C65, and 8% PAA.

Embodiment 18. The anode electrode of Embodiment 17, wherein for the determination of E, measurement of electrode properties of the silicon-carbon composite mixture and the individual fractions comprising each mode are measured under otherwise identical conditions.

Embodiment 19. The anode electrode of any one of Embodiments 15-18, wherein E is greater than 0.05.

Embodiment 20. The anode electrode of any one of Embodiments 15-18, wherein E is greater than 0.1.

Embodiment 21. The anode electrode according to any one of Embodiments 13-20, wherein the silicon-carbon composite mixture comprises at least one further carbon and/or at least one binder.

Embodiment 22. The anode electrode according to Embodiment 21, wherein the at least one further carbon and/or the at least one binder is dissolved in an aqueous medium.

Embodiment 23. The anode electrode according to any one of Embodiments 13-22, wherein the silicon-carbon composite mixture is composed such that the silicon-carbon composite mixture has an electron density ranging from 1.05 g/cm³ to 1.5 g/cm³, or from 1.1 g/cm³ and 1.3 g/cm³.

Embodiment 24. The anode electrode according to any one of Embodiments 13-23, wherein the silicon-carbon composite mixture has an electrical conductivity ranging from 0.3 S/cm to 2 S/cm, or from 0.5 S/cm and 1.2 S/cm.

Embodiment 25. The anode electrode according to any one of Embodiments 13-24, wherein the carbon is a hard carbon material, a graphitic carbon, or a metal oxide.

Embodiment 26. The anode electrode according to any one of Embodiments 13-25, wherein the at least one binder is configured to bind the porous carbon and the silicon content of the first silicon-carbon composite, the porous carbon and the silicon-carbon portion of the second silicon-carbon composite and/or the first silicon-carbon composite and the second silicon-carbon composite.

Embodiment 27. The anode electrode according to any one of Embodiments 13-26, wherein the silicon-carbon composite mixture comprises at least one additional binder.

Embodiment 28. The anode electrode according to any one of Embodiments 21, 22, 26, or 27, wherein the at least one binder or additional binder is a styrene-butadiene gum/carboxymethyl cellulose (CMC/SBR) mixture, a polyacrylic acid (PAA) and/or a lithium polyacrylic (LiPAA) or a sodium polyacrylic (NaPAA).

Embodiment 29. A method of manufacturing an anode electrode according to any one of Embodiments 13-28, comprising the steps:
a) mixing the silicon-carbon composite mixture with at least one carbon, to create a mixture,
b) combining the mixture and a binder solution in a twin screw extruder, thereby forming an electrode paste,
c) applying the electrode paste to a conductor thereby producing at least one electrode,
d) drying the at least one electrode at a temperature of 100° C. to 140° C.

Embodiment 30. An electrochemical storage device, especially formed as a lithium-ion-battery, comprising:
a) at least one anode electrode, according to any one of Embodiments 13-28;
b) at least one electrode, formed as a cathode, comprising a transition metal oxide;
c) a separator disposed between the cathode and the anode; and
d) an electrolyte comprising lithium ions.

Embodiment 31. Usage of a silicon-carbon composite mixture in an anode electrode, the silicon-carbon composite material comprising:
a) a first silicon-carbon composite material comprising:
   i. a porous carbon scaffold comprising micropores and mesopores and a total pore volume no less than 0.5 cm³/g;
   ii. a silicon content from 30% to 70%;
   iii. a plurality of particles comprising a Dv50 of 6 μm to 20 μm;
b) a second silicon-carbon composite material comprising:
   i. a second carbon scaffold comprising micropores and mesopores and a total pore volume no less than 0.5 cm³/g;
   ii. a silicon content from 30% to 70%;
   iii. a plurality of particles comprising a Dv50 of 1 μm to 6 μm; and
c) 10% to 90% by mass of the first silicon-carbon composite material and 10% to 90% by mass of the second silicon-carbon composite material.

Embodiment 32. The use according to Embodiment 31, wherein the surface area of the silicon-carbon composite mixture is less than 30 m²/g.

Embodiment 33. The use according to Embodiment 31 or 32, wherein the anode electrode has a density comprising E greater than 0.01, wherein E is defined as 1−(density for composite mixture)/(mass averaged density for individual fractions), wherein density is the electrode density as measured in an electrode composed of 70 wt % composite, 20 wt % graphite, and 2 wt % Super C65, and 8% PAA.

Embodiment 34. The use according to Embodiment 33, wherein for the determination of E for the silicon-carbon composite mixture and the individual fractions comprising each mode are measured under otherwise identical conditions.

Embodiment 35. The use according to Embodiment 33 or 34, wherein E is greater than 0.05. Embodiment 36. The use according to Embodiment 33 or 34, wherein E is greater than 0.1.

Embodiment 37. Usage of an anode electrode according to anyone of the Embodiments 13-28 in an electrochemical storage device.

Embodiment 38. A method for producing an anode electrode comprising:
a) providing a current collector comprising copper; and
b) applying on the current collector a first anode composition comprising:
   i. a silicon-carbon composite anode active material comprising a plurality of particles comprising a Dv50 of 1 μm to 20 μm;
   ii. a binder; and
   iii. a conductive carbon material comprising a plurality of particles comprising a Dv50 of 1 nm to 1 μm; and
c) applying onto the first anode composition a second anode composition comprising:
   i. a silicon-carbon composite anode active material comprising a plurality of particles comprising a Dv50 of 1 μm to 20 μm;
   ii. a binder; and
   iii. a conductive carbon material comprising a plurality of particles comprising a Dv50 of 1 nm to 1 μm; and
d) wherein the ratio of Dv50 of the silicon-carbon composite material comprised in the first anode composition to the Dv50 of the silicon-carbon composite material comprised in the second anode composition is >1; and
e) wherein the ratio of silicon content of the silicon-carbon composite material comprised in the first anode composition to the silicon content of the silicon-carbon composite material comprised in the second anode composition is <1.

Embodiment 39. The method of preparing an electrode according to Embodiment 38 wherein the first silicon-carbon composite anode active material comprises a carbon scaffold comprises micropores and mesopores and a total pore volume no less than 0.5 cm³/g, a silicon content from 30% to 70%, and a plurality of particles comprising a Dv50 of 1 μm to 6 μm.

Embodiment 40. The method of preparing an electrode according to Embodiment 38 wherein the second silicon-carbon composite anode active material comprises a carbon scaffold comprises micropores and mesopores and a total pore volume no less than 0.5 cm³/g, a silicon content from 30% to 70%, and a plurality of particles comprising a Dv50 of 6 μm to 20 μm.

Embodiment 41. The method of preparing an electrode according to Embodiment 38 wherein:
a) the first silicon-carbon composite anode active material comprises a carbon scaffold comprises micropores and mesopores and a total pore volume no less than 0.5 cm³/g, a silicon content from 30% to 70%, and a plurality of particles comprising a Dv50 less than 6 μm
b) the second silicon-carbon composite anode active material comprises a carbon scaffold comprises micropores and mesopores and a total pore volume no less than 0.5 cm³/g, a silicon content from 30% to 70%, and a plurality of particles comprising a Dv50 of greater than 6 μm.

Embodiment 42. The method of preparing an electrode according to any of Embodiments 38 to 42 wherein the first silicon-carbon composite anode active material comprises graphite.

Embodiment 43. The method of preparing an electrode according to any of Embodiments 38 to 42 wherein the second silicon-carbon composite anode active material comprises graphite.

Embodiment 44. The method of preparing an electrode according to any of Embodiments 38 to 42 wherein the first silicon-carbon composite anode active material comprises graphite, and the second silicon-carbon composite anode active material comprises graphite.

Embodiment 45. The method according of any of Embodiment 38 to Embodiment 44 wherein the silicon content of the second silicon-carbon composite anode active material is less than the silicon content of the first silicon-carbon composite anode active material.

Embodiment 46. The method according of any of Embodiment 38 to Embodiment 44 wherein the silicon content of the second silicon-carbon composite anode active material is greater than the silicon content of the first silicon-carbon composite anode active material.

Embodiment 47. An electrode produced from any of the Embodiments 38-46.

1. A silicon-carbon composite mixture comprising:
a) a first silicon-carbon composite material comprising:
i. a porous carbon scaffold comprising micropores and mesopores and a total pore volume no less than 0.5 cm³/g;
ii. a silicon content from 30% to 70%;
iii. a plurality of particles comprising a Dv50 of 6 μm to 20 μm;
b) a second silicon-carbon composite material comprising:
i. a second carbon scaffold comprising micropores and mesopores and a total pore volume no less than 0.5 cm³/g;
ii. a silicon content from 30% to 70%;
iii. a plurality of particles comprising a Dv50 of 1 μm to 6 μm; and
c) 10% to 90% by mass of the first silicon-carbon composite material and 10% to 90% by mass of the second silicon-carbon composite material.

2. The silicon-carbon composite mixture of claim 1, wherein the mixture further comprises one or more additional silicon-carbon composite wherein each of the one or more additional silicon-carbon composites comprises a unique Dv50.

3. The silicon-carbon composite mixture of claim 1 or 2, wherein the silicon-carbon composite mixture has a surface area of less than 30 m²/g.

4. The silicon-carbon composite mixture of claim 1, 2 or 3, wherein E is greater than 0.01, wherein E is defined as 1−(density for composite mixture)/(mass averaged density for individual fractions), wherein density is the electrode density as measured in an electrode composed of 70 wt % composite, 20 wt % graphite, and 2 wt % Super C65, and 8% PAA.

5. The silicon-carbon composite mixture of claim 4, wherein for the determination of E, measurement of electrode properties of the silicon-carbon composite mixture and the individual fractions comprising each mode are measured under otherwise identical conditions.

6. A silicon-carbon composite mixture comprising:
a) a first silicon-carbon composite material comprising:
i. a porous carbon scaffold comprising micropores and mesopores and a total pore volume no less than 0.5 cm³/g;
ii. a silicon content from 30% to 70%;
iii. a plurality of particles comprising a Dv50 of 6 μm to 20 μm;
b) a second silicon-carbon composite material comprising:
i. a second carbon scaffold comprising micropores and mesopores and a total pore volume no less than 0.5 cm³/g;
ii. a silicon content from 30% to 70%;
iii. a plurality of particles comprising a Dv50 of 1 μm to 6 μm;
c) 10% to 90% by mass of the first silicon-carbon composite material and 10% to 90% by mass of the second silicon-carbon composite material;
d) a surface area of less than 30 m²/g;
e) E greater than 0.01, wherein E is defined as 1−(tap density for composite mixture)/(mass averaged tap density for individual fractions); and
f) for the determination of E, measurement of tap density of the silicon-carbon composite mixture and the individual fractions comprising each mode are measured under otherwise identical conditions.

7. A silicon-carbon composite mixture comprising:
a) a first silicon-carbon composite material comprising:
i. a porous carbon scaffold comprising micropores and mesopores and a total pore volume no less than 0.5 cm³/g;
ii. a silicon content from 30% to 70%;
iii. a plurality of particles comprising a Dv50 of 6 μm to 20 μm;
b) a second silicon-carbon composite material comprising:
i. a second carbon scaffold comprising micropores and mesopores and a total pore volume no less than 0.5 cm³/g;
ii. a silicon content from 30% to 70%;
iii. a plurality of particles comprising a Dv50 of 1 μm to 6 μm;
c) 10% to 90% by mass of the first silicon-carbon composite material and 10% to 90% by mass of the second silicon-carbon composite material;
d) a surface area of less than 30 m²/g; and
e) E greater than 0.01, wherein E is defined as 1−(conductivity for composite material)/(mass averaged conductivity for individual fractions).

8. The silicon-carbon composite mixture of any one of claims 1-7, wherein E is greater than 0.05.

9. The silicon-carbon composite mixture of any one of claims 1-7, wherein E is greater than 0.1.

10. A method to manufacture a silicon-carbon composite mixture comprising the steps:
a) providing a porous carbon scaffold;
b) comminution the porous carbon scaffold to produce at least two particulate fractions, comprising:
i. a first porous carbon composite material comprising a plurality of particles with Dv50=6 μm to 20 μm;
ii. a second porous carbon composite material comprising a particle size distribution with Dv50=1 μm to 6 μm; and
c) impregnation of silicon into the pores of the at least two particulate fractions of porous carbon composite materials by chemical vapor infiltration to produce a first silicon-carbon composite and a second silicon-carbon composite; and
d) blending of the first silicon-carbon composite and the second silicon-carbon composite material.

11. The silicon-carbon composite mixture of any one of claims 1-10, wherein the mixture comprises the first fraction of the first silicon-carbon composite with a proportion of 60% to 90% by weight and the second silicon-carbon composite with a proportion of 10% to 40% by weight.

12. The silicon-carbon composite mixture of any one of claim 1-11, wherein the mixture comprises the first fraction of the first silicon-carbon composite with a proportion of 70% to 90% by weight and the second silicon-carbon composite with a proportion of 10% to 30% by weight.

13. A method to manufacture a silicon-carbon composite mixture comprising the steps:
a) providing a porous carbon scaffold;
b) comminution the porous carbon scaffold to produce at least two particulate fractions, comprising:
i. a first porous carbon composite material comprising a plurality of particles with Dv50=6 μm to 20 μm;
ii. a second porous carbon composite material comprising a particle size distribution with Dv50=1 μm to 6 μm; and
c) impregnation of silicon into the pores of the at least two particulate fractions of porous carbon composite materials by chemical vapor infiltration;
d) applying a coating onto the surface of the at least two particulate fractions of the porous silicon-carbon composite by chemical vapor deposition; and
e) blending of the first particulate silicon-carbon composite material and the second particulate silicon-carbon composite material.

14. An anode electrode, comprising a silicon-carbon composite mixture comprising:
a) a first silicon-carbon composite material comprising:
i. a porous carbon scaffold comprising micropores and mesopores; and a total pore volume no less than 0.5 cm³/g;
ii. a silicon content from 30% to 70%;
iii. a plurality of particles comprising a Dv50 of 6 μm to 20 μm;
b) a second silicon-carbon composite material comprising:
i. a second carbon scaffold comprising micropores and mesopores and a total pore volume no less than 0.5 cm³/g;
ii. a silicon content from 30% to 70%;
iii. a plurality of particles comprising a Dv50 of 1 μm to 6 μm; and
c) 10% to 90% by mass of the first silicon-carbon composite material; and 10% to 90% by mass of the second silicon-carbon composite material.

15. The anode electrode of claim 14, wherein the surface area of the silicon-carbon composite mixture is less than 30 m²/g.

16. The anode electrode of claim 14 or 15, wherein the anode electrode has a density comprising E greater than 0.01, wherein E is defined as 1−(density for composite mixture)/(mass averaged density for individual fractions), wherein density is the electrode density as measured in an electrode composed of 70 wt % composite, 20 wt % graphite, and 2 wt % Super C65, and 8% PAA.

17. The anode electrode of claim 16, wherein for the determination of E, measurement of electrode properties of the silicon-carbon composite mixture and the individual fractions comprising each mode are measured under otherwise identical conditions.

18. The anode electrode of claim 14 or 15, wherein the anode electrode has a density comprising E greater than 0.01, wherein E is defined as 1−(tap density for composite mixture)/(mass averaged tap density for individual fractions), wherein density is the electrode density as measured in an electrode composed of 70 wt % composite, 20 wt % graphite, and 2 wt % Super C65, and 8% PAA.

19. The anode electrode of claim 18, wherein for the determination of E, measurement of electrode properties of the silicon-carbon composite mixture and the individual fractions comprising each mode are measured under otherwise identical conditions.

20. The anode electrode of any one of claims 16-19, wherein E is greater than 0.05.

21. The anode electrode of any one of claims 16-19, wherein E is greater than 0.1.

22. The anode electrode according to any one of claims 14-21, wherein the silicon-carbon composite mixture comprises at least one further carbon and/or at least one binder.

23. The anode electrode according to claim 22, wherein the at least one further carbon and/or the at least one binder is dissolved in an aqueous medium.

24. The anode electrode according to any one of claims 14-23, wherein the silicon-carbon composite mixture is composed such that the silicon-carbon composite mixture has an electron density ranging from 1.05 g/cm³ to 1.5 g/cm³, or from 1.1 g/cm³ and 1.3 g/cm³.

25. The anode electrode according to any one of claims 14-24, wherein the silicon-carbon composite mixture has an electrical conductivity ranging from 0.3 S/cm to 2 S/cm, or from 0.5 S/cm and 1.2 S/cm.

26. The anode electrode according to any one of claims 14-25, wherein the carbon is a hard carbon material, a graphitic carbon, or a metal oxide.

27. The anode electrode according to any one of claims 14-26, wherein the at least one binder is configured to bind the porous carbon and the silicon content of the first silicon-carbon composite, the porous carbon and the silicon-carbon portion of the second silicon-carbon composite and/or the first silicon-carbon composite and the second silicon-carbon composite.

28. The anode electrode according to any one of claims 14-27, wherein the silicon-carbon composite mixture comprises at least one additional binder.

29. The anode electrode according to any one of claim 22, 23, 27, or 28, wherein the at least one binder or additional binder is a styrene-butadiene gum/carboxymethylcellulose (CMC/SBR) mixture, a polyacrylic acid (PAA) and/or a lithium polyacrylic (LiPAA) or a sodium polyacrylic (NaPAA).

30. A method of manufacturing an anode electrode according to any one of claims 14-29, comprising the steps:
a) mixing the silicon-carbon composite mixture with at least one carbon, to create a mixture;
b) combining the mixture and a binder solution in a twin screw extruder, thereby forming an electrode paste;
c) applying the electrode paste to a conductor thereby producing at least one electrode; and
d) drying the at least one electrode at a temperature of 100° C. to 140° C.

31. An electrochemical storage device, especially formed as a lithium-ion-battery, comprising:
a) at least one anode electrode, according to any one of claims 14-29;
b) at least one electrode, formed as a cathode, comprising a transition metal oxide;
c) a separator disposed between the cathode and the anode; and
d) an electrolyte comprising lithium ions.

32. Usage of a silicon-carbon composite mixture in an anode electrode, the silicon-carbon composite material comprising:
a) a first silicon-carbon composite material comprising:
i. a porous carbon scaffold comprising micropores and mesopores and a total pore volume no less than 0.5 cm³/g;
ii. a silicon content from 30% to 70%;
iii. a plurality of particles comprising a Dv50 of 6 μm to 20 μm;
b) a second silicon-carbon composite material comprising:
i. a second carbon scaffold comprising micropores and mesopores and a total pore volume no less than 0.5 cm³/g;
ii. a silicon content from 30% to 70%;
iii. a plurality of particles comprising a Dv50 of 1 μm to 6 μm; and
c) 10% to 90% by mass of the first silicon-carbon composite material and 10% to 90% by mass of the second silicon-carbon composite material.

33. The use according to claim 32, wherein the surface area of the silicon-carbon composite mixture is less than 30 m²/g.

34. The use according to claim 32 or 33, wherein the anode electrode has a density comprising E greater than 0.01, wherein E is defined as 1−(density for composite mixture)/(mass averaged density for individual fractions), wherein density is the electrode density as measured in an electrode composed of 70 wt % composite, 20 wt % graphite, and 2 wt % Super C65, and 8% PAA.

35. The use according to claim 34, wherein for the determination of E for the silicon-carbon composite mixture and the individual fractions comprising each mode are measured under otherwise identical conditions.

36. The use according to claim 34 or 35, wherein E is greater than 0.05.

37. The use according to claim 34 or 35, wherein E is greater than 0.1.

38. Usage of an anode electrode according to anyone of the claims 14-29 in an electrochemical storage device.
